(19) United States
(12) Patent Application Publication
(10) Pub. No.: US 2026/0058034 A1
(43) Pub. Date: Feb. 26, 2026

(54) WIRE HARNESS AND BUS BAR MODULE

(71) Applicant: YAZAKI CORPORATION, Tokyo (JP)

(72) Inventors: Katsunori Sato, Makinohara-shi (JP); Tatsuya Oga, Makinohara-shi (JP); Mariko Nakagawa, Makinohara-shi (JP); Seigo Mochizuki, Fujieda-shi (JP)

(21) Appl. No.: 19/305,657

(22) Filed: Aug. 20, 2025

(30) Foreign Application Priority Data
Aug. 22, 2024 (JP) 2024-140733

(51) Int. Cl. H01B 7/00; H02G 5/06

(52) U.S. Cl. CPC H01B 7/0045; H02G 5/06

(57) ABSTRACT

A wire harness includes a flat wiring member and a case including a wiring path that accommodates the flat wiring member. The wiring path includes a bottom wall facing the flat wiring member and a pair of side walls arranged on both sides in a width direction with respect to the bottom wall. The flat wiring member is accommodated in the wiring path by pressing both ends in the width direction against the pair of side walls. A cross-sectional shape of the flat wiring member on a cross section orthogonal to an extension direction of the wiring path is a shape curved toward a depth direction of the wiring path.

### CROSS-REFERENCE TO RELATED APPLICATION(S)

The present application claims priority to and incorporates by reference the entire contents of Japanese Patent Application No. 2024-140733 filed in Japan on Aug. 22, 2024.

### BACKGROUND OF THE INVENTION

### 1. Field of the Invention

The present invention relates to a wire harness and a bus bar module.

### 2. Description of the Related Art

In the related art, there is a bus bar module that includes a flat wiring member. Japanese Patent Application Laid-open No. JP 2023-009471 A discloses a bus bar module that includes a current sensor and a main body including a case, a bus bar, and a flexible thin plate-shaped electric wire.

When the flat wiring member is accommodated in the case, it is desired to be able to restrain rattling of the flat wiring member with respect to the case.

### SUMMARY OF THE INVENTION

An object of the present invention is to provide a wire harness and a bus bar module capable of restraining rattling of a flat wiring member with respect to a case.

In order to achieve the above mentioned object, a wire harness according to one aspect of the present invention includes a flat wiring member; and a case including a wiring path that accommodates the flat wiring member, wherein the wiring path includes a bottom wall facing the flat wiring member, and a pair of side walls arranged on both sides in a width direction with respect to the bottom wall, the flat wiring member is accommodated in the wiring path by pressing both ends in the width direction against the pair of side walls, and a cross-sectional shape of the flat wiring member on a cross section orthogonal to an extension direction of the wiring path is a shape curved toward a depth direction of the wiring path.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a view illustrating a wire harness and a bus bar module according to an embodiment;

FIG. 2 is a view illustrating a wire harness and a bus bar module assembled to a battery module;

FIG. 3 is a plan view illustrating a flat wiring member according to the embodiment;

FIG. 4 is a plan view illustrating the case according to the embodiment;

FIG. 5 is a perspective view illustrating the wire harness according to the embodiment;

FIG. 6 is a cross-sectional view illustrating the wire harness according to the embodiment;

FIG. 7 is a side view illustrating the wire harness and the bus bar module according to the embodiment;

FIG. 8 is a side view illustrating the wire harness according to the embodiment;

FIG. 9 is a plan view illustrating a flat wiring member according to the embodiment;

FIG. 10 is a view illustrating another wire harness and bus bar module according to the embodiment; and

FIG. 11 is a cross-sectional view illustrating another wire harness and bus bar module according to the embodiment.

### DETAILED DESCRIPTION OF THE PREFERRED EMBODIMENTS

Hereinafter, a wire harness and a bus bar module according to an embodiment of the present invention will be described in detail with reference to the drawings. The present invention is not limited by the embodiment. Constituent elements in the following embodiment include those that can be easily assumed by those skilled in the art or those that are substantially the same.

### EMBODIMENT

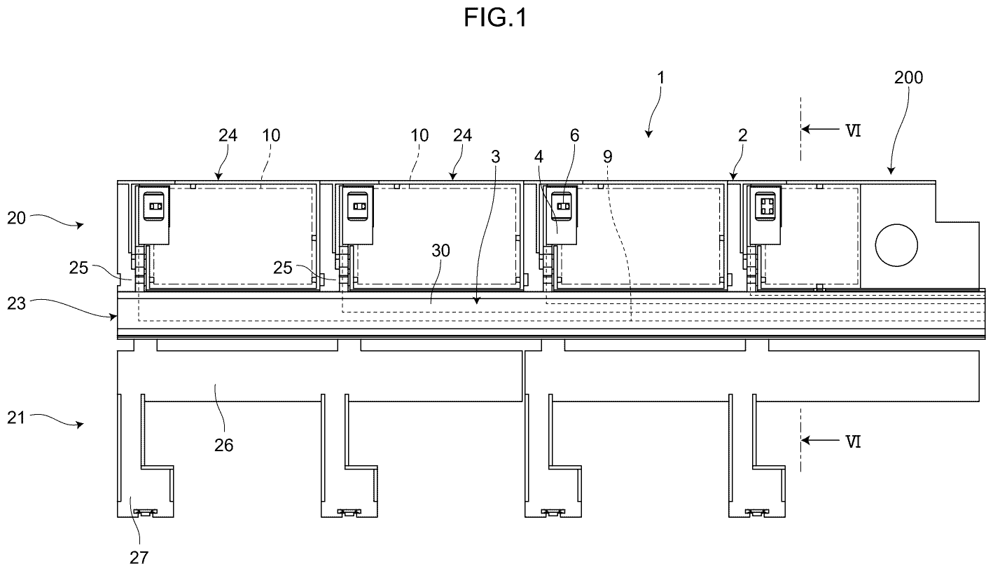

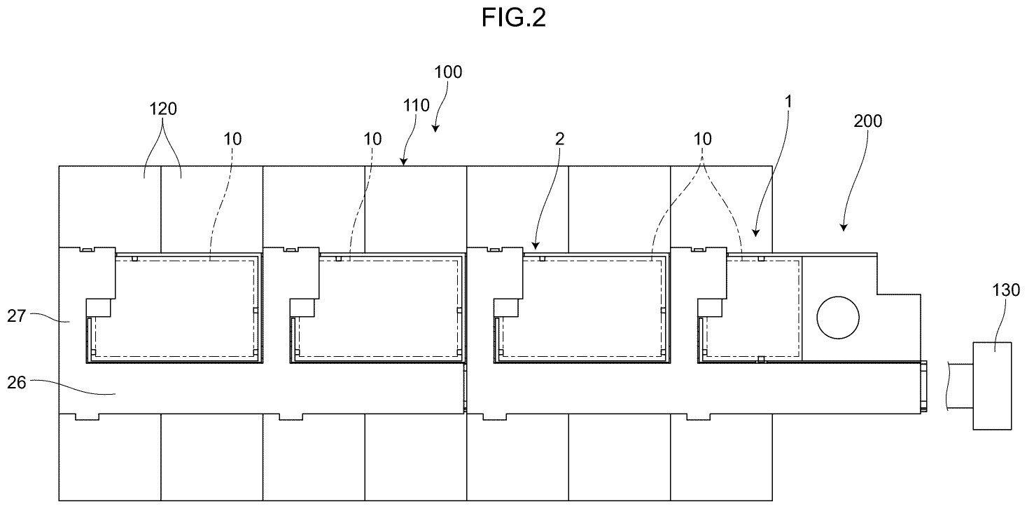

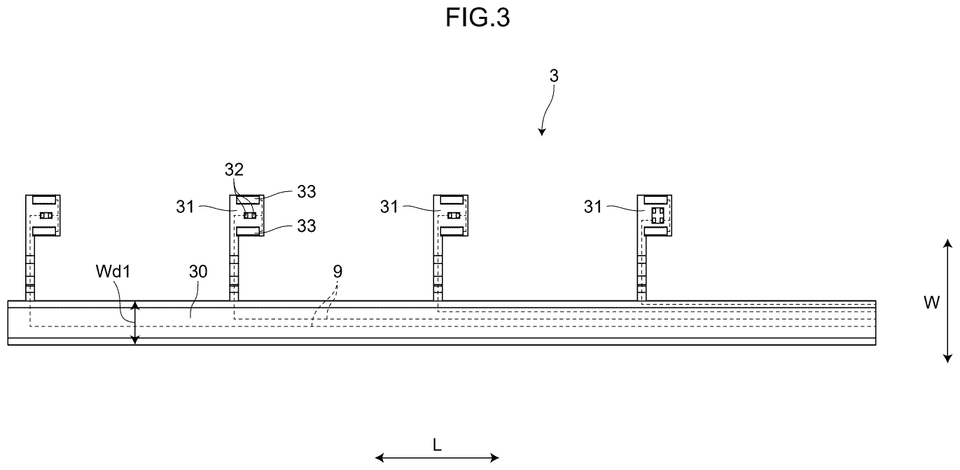

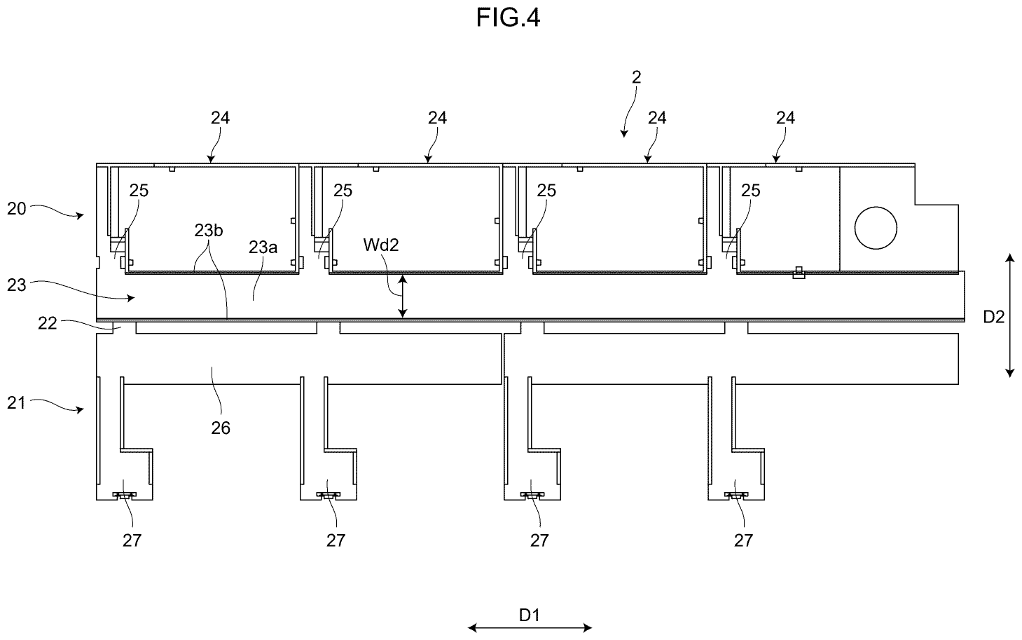

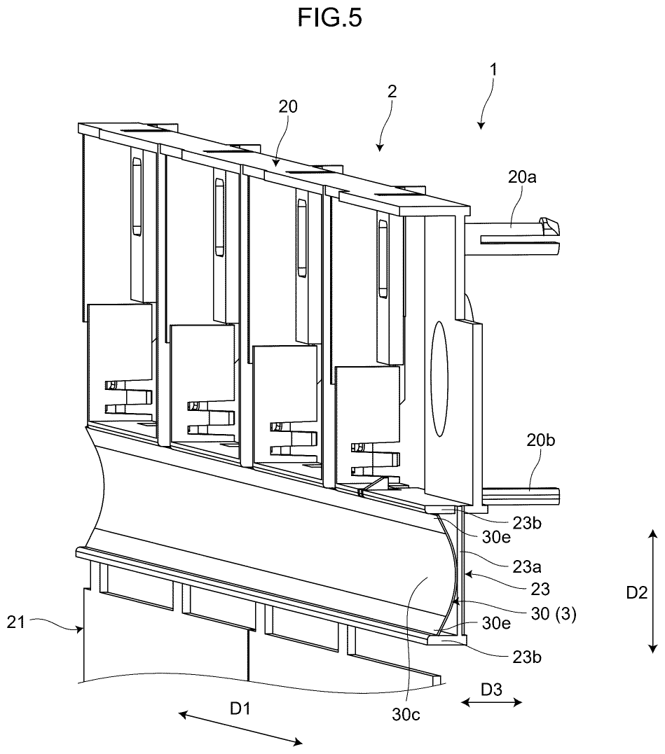

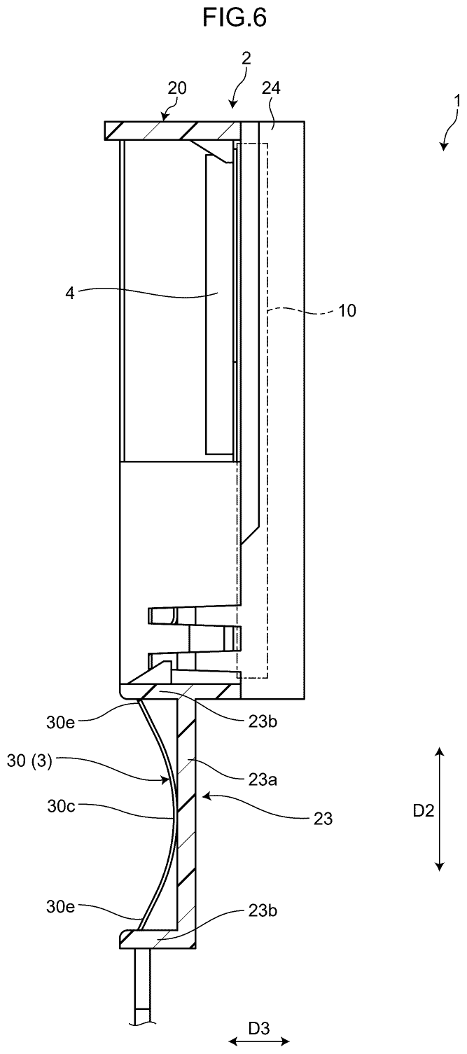

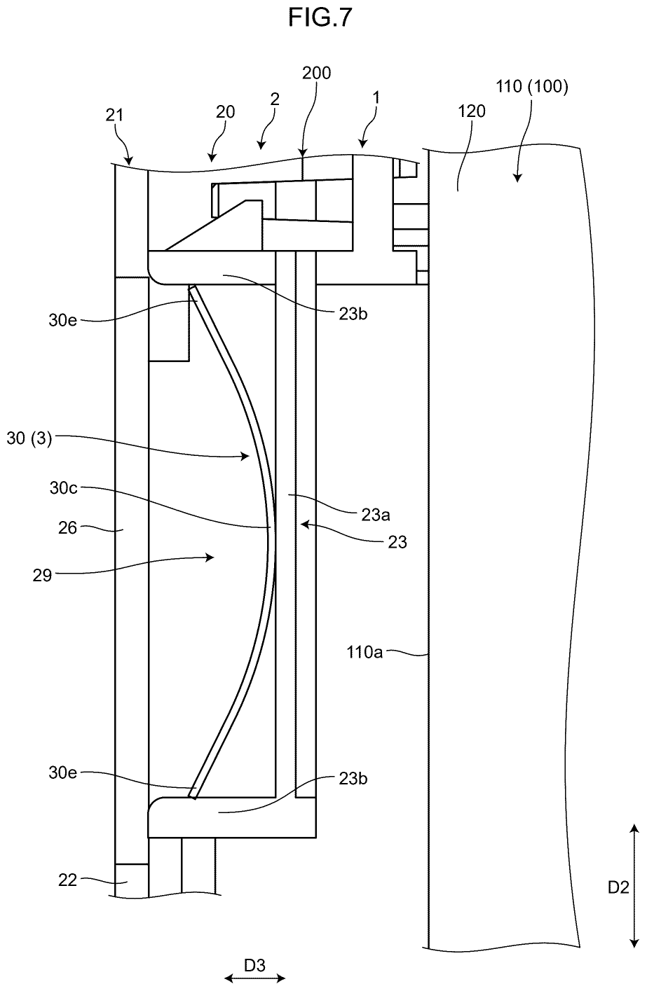

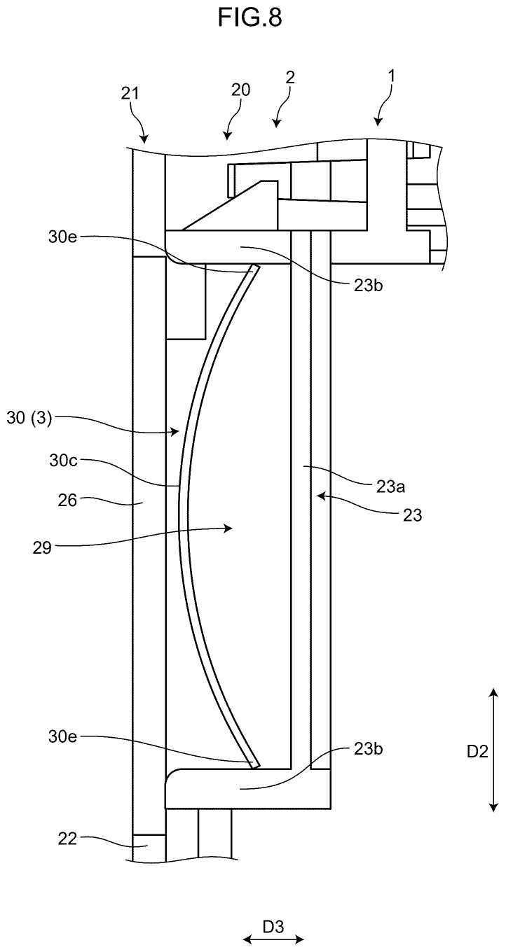

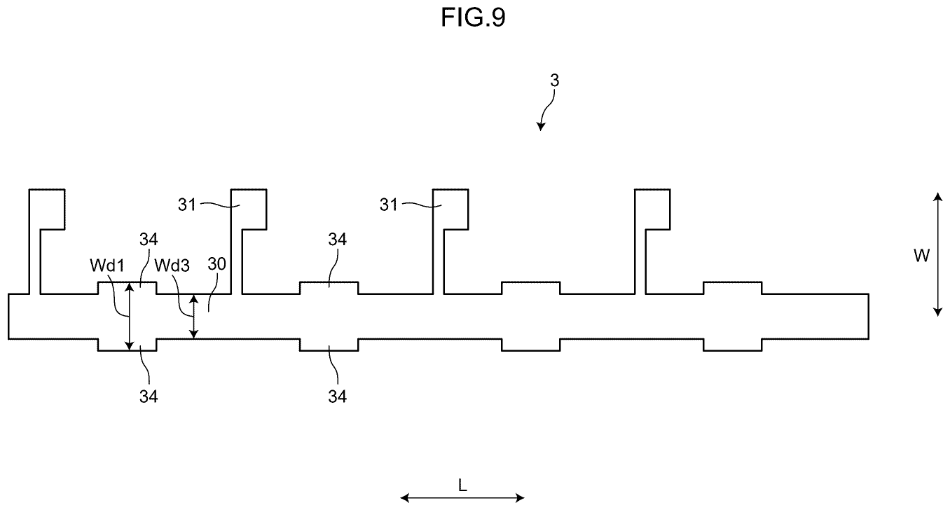

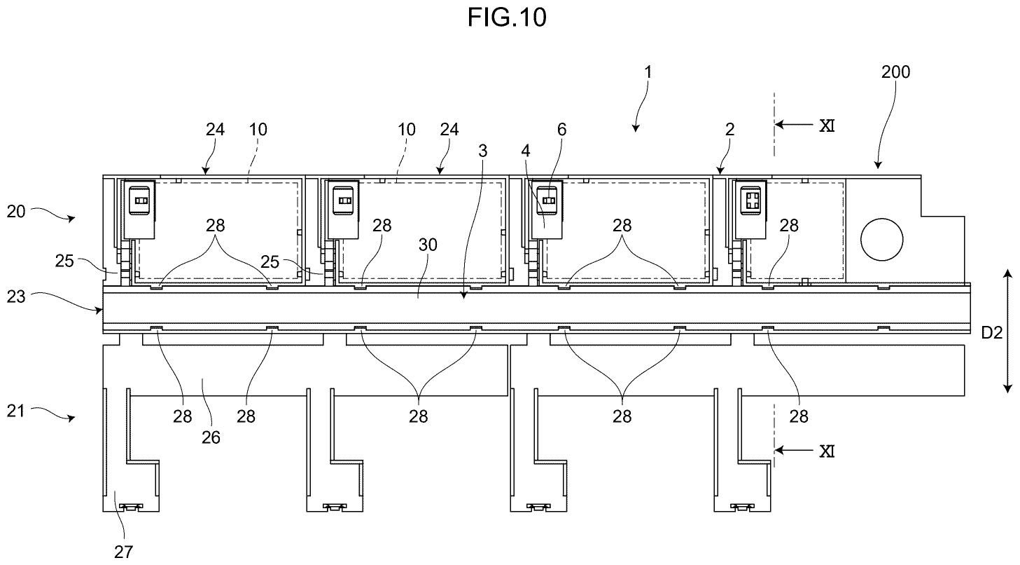

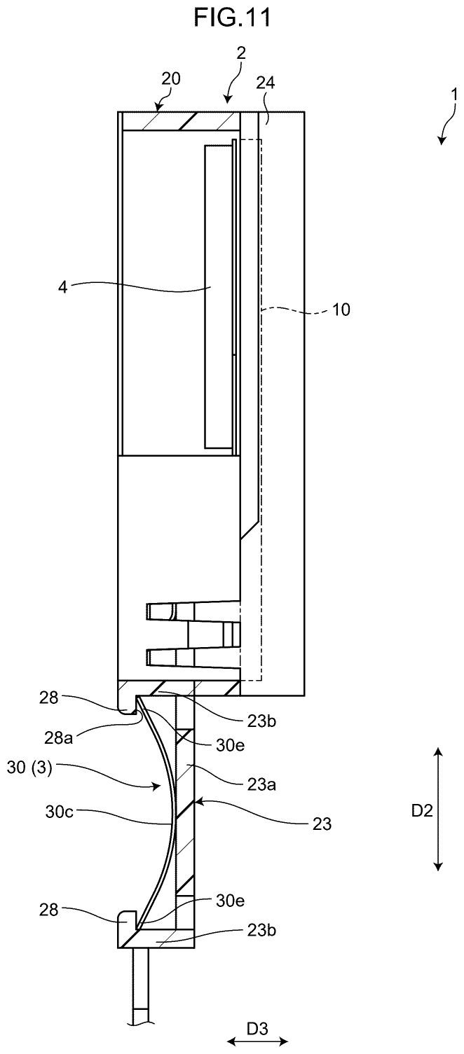

An embodiment will be described with reference to FIGS. 1 to 11. The present embodiment relates to a wire harness and a bus bar module. FIG. 1 is a view illustrating a wire harness and a bus bar module according to an embodiment, FIG. 2 is a view illustrating a wire harness and a bus bar module assembled to a battery module, FIG. 3 is a plan view illustrating a flat wiring member according to an embodiment, FIG. 4 is a plan view illustrating a case according to an embodiment, FIG. 5 is a perspective view illustrating a wire harness according to an embodiment, FIG. 6 is a cross-sectional view illustrating the wire harness according to an embodiment, FIG. 7 is a side view illustrating the wire harness and the bus bar module according to an embodiment, FIG. 8 is a side view illustrating the wire harness according to an embodiment, FIG. 9 is a plan view illustrating a flat wiring member according to an embodiment, FIG. 10 is a view illustrating another wire harness and bus bar module according to an embodiment, and FIG. 11 is a cross-sectional view illustrating another wire harness and bus bar module according to an embodiment. FIG. 6 illustrates a cross section taken along line VI-VI in FIG. 1. FIG. 11 illustrates a cross section taken along line XI-XI in FIG. 10.

As illustrated in FIG. 1, a wire harness 1 according to the present embodiment includes a case 2 and a flat wiring member 3. The illustrated case 2 is able to accommodate and hold a plurality of bus bars 10. The wire harness 1 can be combined with the bus bar 10 to configure a bus bar module 200.

As illustrated in FIG. 2, the wire harness 1 and the bus bar module 200 can be applied to a battery module 110 of a battery pack 100. The battery module 110 includes a plurality of battery cells 120 arranged in an arrangement direction AR. The battery pack 100 is mounted as, for example, a power source on a vehicle such as an electric vehicle or a hybrid electric vehicle.

The bus bar 10 is a conductor formed of a conductive metal plate and is fixed to an electrode of the battery cell 120. The bus bar 10 connects, for example, two adjacent battery cells 120 in series. The flat wiring member 3 connects the plurality of bus bars 10 to a monitoring device 130 of the battery pack 100. The flat wiring member 3 may connect a thermistor arranged in the battery cell 120 to the monitoring device 130. The monitoring device 130 is a device that monitors a state such as a voltage or a temperature of the battery cell 120.

The flat wiring member 3 is connected to the monitoring device 130 via, for example, a connector. As illustrated in FIG. 1, the flat wiring member 3 has a plurality of detection lines 9. The flat wiring member 3 is, for example, a flexible printed circuit board. The flexible printed circuit board has a base film, a coverlay, and a conductive layer. The base film and the coverlay are flexible insulating resin layers. The conductive layer is sandwiched and protected by the base film and the coverlay. The conductive layer is, for example, a conductive metal foil and includes a plurality of circuit patterns including the detection line 9. The detection line 9 is connected to a circuit of the monitoring device 130.

The detection line 9 is connected to the bus bar 10 via a chip fuse 6 mounted on the flat wiring member 3. The chip fuse 6 is a protection component that protects a circuit. In the wire harness 1 according to the present embodiment, a plate member 4 is interposed between the chip fuse 6 and the bus bar 10. The plate member 4 is connected to the bus bar 10 by welding or the like, and electrically connects the chip fuse 6 to the bus bar 10. The plate member 4 according to the present embodiment is arranged on the flat wiring member 3 as a voltage detection terminal that detects a voltage of the battery cell 120.

As illustrated in FIG. 3, the flat wiring member 3 includes a trunk line 30 and a plurality of branch portions 31. The trunk line 30 has a longitudinal direction L and a width direction W. A shape of the trunk line 30 in a plan view is, for example, rectangular. The plurality of detection lines 9 extend along the trunk line 30 in the longitudinal direction L. The trunk line 30 has a width Wd1. The branch portion 31 branches from an edge in the width direction W of the trunk line 30. The branch portion 31 according to the present embodiment extends in the width direction W from the trunk line 30. At least one detection line 9 is arranged in the branch portion 31.

The conductive layer of the flat wiring member 3 includes pads 32 and 33 provided on the branch portion 31. The chip fuse 6 is connected to the pair of pads 32 by solder or the like. The chip fuse 6 mounted on the flat wiring member 3 is interposed between the detection line 9 and the pad 33. The plate member 4 is connected to the pair of pads 33 by solder or the like. That is, the plate member 4 is connected to the detection line 9 via the chip fuse 6.

As illustrated in FIG. 4, the case 2 includes a case body 20, a cover body 21, and a hinge portion 22. The case 2 is molded using, for example, an insulating synthetic resin. The case body 20, the cover body 21, and the hinge portion 22 accordingly the present embodiment are integrally molded. The cover body 21 is connected to the case body 20 via the flexible hinge portion 22.

The case body 20 includes a wiring path 23, a plurality of holding portions 24, and a plurality of support walls 25. The wiring path 23 is a path for accommodating the trunk line 30 of the flat wiring member 3. The extension direction D1 of the wiring path 23 is a longitudinal direction of the case 2. The holding portion 24 holds and accommodates the bus bar 10. The holding portion 24 has a rectangular frame shape and has a locking protrusion that locks the bus bar 10. The plurality of holding portions 24 are arranged along the wiring path 23 and in the extension direction D1.

The support wall 25 supports the branch portion 31 of the flat wiring member 3. The support wall 25 branches from the wiring path 23 in the width direction D2 orthogonal to the extension direction D1. The support wall 25 protrudes from the wiring path 23 toward a side opposite to the cover body 21 side and is arranged along the holding portion 24.

The wiring path 23 includes a bottom wall 23a and a pair of side walls 23b. The bottom wall 23a is a wall facing the trunk line 30 of the flat wiring member 3. The bottom wall 23a extends in the extension direction D1. The shape of the wiring path 23 in a plan view is rectangular. The bottom wall 23a is provided from one end to the other end of the case body 20. The pair of side walls 23b are arranged on both sides in the width direction D2 with respect to the bottom wall 23a. The pair of side walls 23b face each other in the width direction D2. The wiring path 23 has a width Wd2. The width Wd2 is a distance between one side wall 23b and the other side wall 23b. The width Wd2 of the wiring path 23 is narrower than the width Wd1 of the trunk line 30.

The cover body 21 includes a first cover 26 that covers the wiring path 23 and a plurality of second covers 27. The shape of the first cover 26 in a plan view is rectangular. The first cover 26 is connected to the side wall 23b of the wiring path 23 via the hinge portion 22. The second cover 27 covers the support wall 25 of the case body 20. The second cover 27 extends from the first cover 26 in the width direction D2. The plurality of second covers 27 are arranged in the extension direction D1.

In the wire harness 1 according to the present embodiment, the flat wiring member 3 is press-fitted into the wiring path 23, as will be described below. Accordingly, rattling of the flat wiring member 3 with respect to the case 2 is restrained.

As illustrated in FIGS. 5 and 6, the side wall 23b is erected from the end of the bottom wall 23a in the width direction D2. The trunk line 30 of the flat wiring member 3 is accommodated in the wiring path 23 in a state where the trunk line 30 has a curved shape. The bottom wall 23a of the wiring path 23 faces the trunk line 30 in the depth direction D3. The trunk line 30 is accommodated in the wiring path 23 by pressing both ends 30e in the width direction against the pair of side walls 23b. That is, the trunk line 30 is accommodated in the wiring path 23 by pressing one end 30e against one side wall 23b and pressing the other end 30e against the other side wall 23b. Accordingly, the trunk line 30 is sandwiched from both sides in the width direction D2 by the pair of side walls 23b.

The cross-sectional shape of the trunk line 30 on the cross section orthogonal to the extension direction D1 of the wiring path 23 is a shape curved toward the depth direction D3 of the wiring path 23. In the flat wiring member 3 illustrated in FIGS. 5 and 6, the trunk line 30 has a shape curved toward the bottom wall 23a. That is, a central portion 30c in the width direction is curved to protrude toward a bottom wall 23a with respect to both ends 30e.

Since the end 30e in the width direction of the trunk line 30 is supported by the side wall 23b, rattling of the flat wiring member 3 is restrained. For example, the side wall 23b can restrain rattling of the flat wiring member 3 in the width direction D2. The side wall 23b can restrain rattling of the flat wiring member 3 in the depth direction D3. The trunk line 30 may be accommodated in the wiring path 23 with the central portion 30c in the width direction being in contact with the bottom wall 23a. In this case, the bottom wall 23a supports the central portion 30c, and can restrain rattling of the flat wiring member 3 in the depth direction D3.

For example, the flat wiring member 3 is accommodated in the case 2 with the bus bar 10 being connected. In this case, the chip fuse 6 and the plate member 4 are mounted on each branch portion 31, and the plate member 4 is joined to the bus bar 10. Each of the plurality of bus bars 10 is accommodated in the corresponding holding portion 24, and the trunk line 30 of the flat wiring member 3 is pushed into the wiring path 23. Work of assembling the flat wiring member 3 and the bus bar 10 to the case 2 is performed by, for example, a worker. The worker pushes the trunk line 30 of the flat wiring member 3 into the wiring path 23 while curving the trunk line 30. When the trunk line 30 is pushed into the wiring path 23, both the ends 30e of the trunk line 30 are pressed against the side wall 23b and supported by the side wall 23b.

The flat wiring member 3 may be connected to the bus bar 10 after being accommodated in the case 2. In this case, the chip fuse 6 and the plate member 4 are mounted on each branch portion 31 in advance. The plate member 4 is joined to, for example, the bus bar 10 held by the case 2. The work of assembling the bus bar 10 to the case 2 and the work of assembling the flat wiring member 3 to the case 2 are performed by, for example, the worker.

After the flat wiring member 3 is accommodated in the wiring path 23, the cover body 21 is closed. FIG. 7 illustrates the cover body 21 in a closed state. The first cover 26 of the cover body 21 faces the bottom wall 23a and the trunk line 30 of the flat wiring member 3 in the depth direction D3. The first cover 26 covers the wiring path 23 and forms an accommodation space 29. The accommodation space 29 is a space for accommodating the trunk line 30 of the flat wiring member 3 and is surrounded by the first cover 26, the bottom wall 23a, and the pair of side walls 23b. The first cover 26 restricts movement of the trunk line 30 so that the trunk line 30 does not come out of the wiring path 23. The first cover 26 can maintain the curved shape of the trunk line 30 by positioning the trunk line 30 inside the wiring path 23.

The bus bar module 200 is assembled to the battery module 110 with the cover body 21 of the case 2 being closed. As illustrated in FIG. 5, the case 2 has engagement portions 20a and 20b that engage with the battery module 110. The engagement portions 20a and 20b protrude from the case body 20 in the depth direction D3. For example, the engagement portions 20a and 20b engage with an end plate of the battery module 110 to fix the case body 20 to the battery module 110.

As illustrated in FIG. 7, the battery module 110 has a side surface 110a in the vertical direction. The side surface 110a is a surface in a vehicle vertical direction in a state where the battery pack 100 is mounted on the vehicle. The bus bar module 200 is assembled to the battery module 110 such that the bottom wall 23a faces the side surface 110a in the vertical direction. In this case, the width direction D2 of the wiring path 23 is the vertical direction, and the pair of side walls 23b face each other in the vertical direction.

The trunk line 30 of the flat wiring member 3 is supported by the side walls 23b from both sides in the vertical direction. Accordingly, rattling of the flat wiring member 3 in response to vibration in the vertical direction is restrained. The side wall 23b can hold the trunk line 30 and restrain rattling of the flat wiring member 3 in response to vibration in the horizontal direction. For example, rattling of the flat wiring member 3 in response to vibration in the depth direction D3 is restrained.

FIG. 8 illustrates an example of a curved shape of the flat wiring member 3 accommodated in the wiring path 23. The trunk line 30 accommodated in the wiring path 23 may have a shape curved toward the side opposite to the bottom wall 23a. In this case, the cross-sectional shape of the trunk line 30 on the cross section orthogonal to the extension direction D1 is a curved shape in which both ends 30e are located on the bottom wall 23a side with respect to the central portion 30c. The trunk line 30 may be accommodated in the wiring path 23 with the central portion 30c being in contact with the first cover 26.

The flat wiring member 3 may include a widened portion 34 in a part of the trunk line 30. FIG. 9 illustrates the flat wiring member 3 that includes the widened portion 34. The widened portion 34 is arrayed on both sides in the width direction W with respect to the trunk line 30. That is, in the portion including the widened portion 34, both ends in the width direction W of the trunk line 30 protrude in the width direction W. The shape of the widened portion 34 in a plan view is, for example, rectangular or trapezoidal.

In the trunk line 30, the width Wd1 of the portion having the widened portion 34 is larger than the width Wd3 of the portion not having the widened portion 34. The width Wd1 of the portion having the widened portion 34 is larger than the width Wd2 of the wiring path 23. The width Wd3 of the portion that does not include the widened portion 34 is, for example, smaller than the width Wd2 of the wiring path 23. In the flat wiring member 3 illustrated in FIG. 9, the widened portions 34 are arranged at a plurality of locations of the trunk line 30. The widened portion 34 is arranged, for example, between two adjacent branch portions 31. The plurality of widened portions 34 may be arranged at equal intervals in the longitudinal direction L.

The trunk line 30 is accommodated in the wiring path 23 by pressing the widened portions 34 at both ends in the width direction W against the pair of side walls 23b. Since a plurality of portions of the trunk line 30 are press-fitted into the wiring path 23, rattling of the flat wiring member 3 is appropriately restrained.

FIGS. 10 and 11 illustrate the case 2 that includes a locking portion 28. The locking portion 28 is configured to lock the flat wiring member 3 so that rattling of the flat wiring member 3 can be restrained. The locking portion 28 in FIGS. 10 and 11 is arranged in the wiring path 23 of the case 2. More specifically, the locking portion 28 is a protrusion protruding from the pair of side walls 23b.

As illustrated in FIG. 10, the plurality of locking portions 28 is arranged on each side wall 23b at intervals in the extension direction D1. The locking portion 28 is arranged, for example, between two adjacent support walls 25. The locking portion 28 arranged on one side wall 23b and the locking portion 28 arranged on the other side wall 23b face each other in the width direction D2.

As illustrated in FIG. 11, the locking portion 28 protrudes in the width direction D2 from the inner wall surface of the side wall 23b. The locking portion 28 protrudes from the tip of the side wall 23b. The locking portion 28 has a locking surface 28a facing the bottom wall 23a. The trunk line 30 of the flat wiring member 3 is accommodated in the wiring path 23 to be curved toward the bottom wall 23a. The locking portion 28 locks the end 30e of the trunk line 30 by the locking surface 28a. The case 2 that includes the locking portion 28 can stabilize a posture of the trunk line 30 by locking the end 30e of the trunk line 30. The locking portion 28 can restrict movement of the trunk line 30 to prevent the trunk line 30 from protruding from the wiring path 23.

The trunk line 30 may be inserted into the wiring path 23 such that the central portion 30c in the width direction is brought into contact with the bottom wall 23a and both the ends 30e are locked by the locking portions 28. In this case, rattling of the flat wiring member 3 is effectively restrained by supporting the both the ends 30e and the central portion 30c of the trunk line 30. When the flat wiring member 3 includes the widened portion 34, the locking portion 28 is preferably provided at a position at which the widened portion 34 can be locked.

The portion where the locking portion 28 is provided is not limited to the side wall 23b. The case 2 may include, for example, the locking portion 28 provided on the cover body 21. In this case, the locking portion 28 may be a protrusion protruding from the first cover 26 toward the bottom wall 23a.

As described above, the wire harness 1 according to the present embodiment includes the flat wiring member 3 and the case 2. The case 2 includes the wiring path 23 that accommodates the flat wiring member 3. The wiring path 23 includes a bottom wall 23a facing the flat wiring member 3 and the pair of side walls 23b arranged on both sides in the width direction D2 with respect to the bottom wall 23a. The flat wiring member 3 is accommodated in the wiring path 23 by pressing both the ends 30e in the width direction against the pair of side walls 23b. The cross-sectional shape of the flat wiring member 3 on the cross section orthogonal to the extension direction D1 of the wiring path 23 is a shape curved toward the depth direction D3 of the wiring path 23. Since both the ends 30e of the curved flat wiring member 3 are pressed against the side wall 23b, rattling of the flat wiring member 3 in the wiring path 23 is restrained.

The flat wiring member 3 according to the present embodiment includes the trunk line 30 and the branch portion 31 branching from the trunk line 30. In this case, for example, the flat wiring member 3 is accommodated in the wiring path 23 by pressing both the ends 30e in the width direction of the trunk line 30 against the pair of side walls 23b. Since the trunk line 30 is supported from both sides by the side wall 23b, rattling of the flat wiring member 3 is restrained.

The case 2 may include the locking portion 28 that locks both the ends 30e in the width direction of the flat wiring member 3 accommodated in the wiring path 23. In this case, the cross-sectional shape of the flat wiring member 3 on the cross section orthogonal to the extension direction D1 of the wiring path 23 is a shape curved toward the bottom wall 23a. Since both the ends 30e are locked by the locking portion 28, rattling of the flat wiring member 3 is restrained.

The locking portion 28 is, for example, a protrusion protruding from the pair of side walls 23b. In this case, the locking portion 28 locks both ends 30e of the flat wiring member 3 press-fitted into the wiring path 23, and can stabilize the posture of the flat wiring member 3.

The bus bar module 200 according to the present embodiment includes the wire harness 1 and the bus bar 10 held by the case 2 and connected to the flat wiring member 3. The bus bar module 200 is assembled to the battery module 110 such that the bottom wall 23a faces the side surface 110a in the vertical direction of the battery module 110. When the bottom wall 23a of the wiring path 23 faces the side surface 110a in the vertical direction, rattling of the flat wiring member 3 is likely to occur unless the flat wiring member 3 is held. In the bus bar module 200 according to the present embodiment, since the flat wiring member 3 is held by the pair of side walls 23b, rattling of the flat wiring member 3 is restrained.

The flat wiring member 3 is not limited to the flexible printed circuit board. The flat wiring member 3 may be a flexible flat cable (FFC) or another elastically deformable plate-like wiring member.

The content disclosed in the above embodiments can be appropriately combined and executed.

In a wire harness according to an aspect of the present embodiment, a wiring path of a case includes a bottom wall facing a flat wiring member, and a pair of side walls arranged on both sides in a width direction with respect to the bottom wall. The flat wiring member is accommodated in the wiring path by pressing both ends in the width direction against the pair of side walls. A cross-sectional shape of the flat wiring member on the cross section orthogonal to the extension direction of the wiring path is a shape curved toward a depth direction of the wiring path. In the wire harness according to the present embodiment, the flat wiring member is held by the pair of side walls. It is possible to restrain rattling of the flat wiring member with respect to the case.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness comprising:
a flat wiring member; and
a case including a wiring path that accommodates the flat wiring member, wherein
the wiring path includes a bottom wall facing the flat wiring member, and a pair of side walls arranged on both sides in a width direction with respect to the bottom wall,
the flat wiring member is accommodated in the wiring path by pressing both ends in the width direction against the pair of side walls, and
a cross-sectional shape of the flat wiring member on a cross section orthogonal to an extension direction of the wiring path is a shape curved toward a depth direction of the wiring path.

2. The wire harness according to claim 1, wherein
the flat wiring member includes a trunk line and a branch portion branching from the trunk line, and
the flat wiring member is accommodated in the wiring path by pressing both ends of the trunk line in the width direction against the pair of side walls.

3. The wire harness according to claim 1, wherein
the case includes a locking portion that locks both ends in the width direction of the flat wiring member accommodated in the wiring path, and
the cross-sectional shape of the flat wiring member on the cross section orthogonal to the extension direction of the wiring path is a shape curved toward the bottom wall.

4. The wire harness according to claim 3, wherein
the locking portion is a protrusion protruding from the pair of side walls.

5. A bus bar module comprising:
the wire harness according to claim 1; and
a bus bar held by the case and connected to the flat wiring member, wherein
the bottom wall is assembled to a battery module so that the bottom wall faces a side surface of the battery module in a vertical direction.
